(19) United States
(12) Patent Application Publication
(10) Pub. No.: US 2008/0086931 A1
(43) Pub. Date: Apr. 17, 2008

(54) Flycatcher

(76) Inventor: Pin-Hsing Liao, Erlin Township (TW)

Correspondence Address: BRUCE H. TROXELL, SUITE 1404, 5205 LEESBURG PIKE, FALLS CHURCH, VA, 22041, US

(21) Appl. No.: 11/580,291

(22) Filed: Oct. 13, 2006

(51) Int. Cl. A01M 1/10

(52) U.S. Cl. 43/107

(57) ABSTRACT

A flycatcher includes a circular disc with an hollow interior, a net bag fixed on the circular disc, a plurality of support legs supporting the circular disc, and an opaque conical bellows-shaped cover combined under the circular disc and hiding the support legs. The bellows-shaped cover is made like a paper lantern collapsible, permitting the flycatcher reducing its dimensions for convenience of packaging and transporting in addition to catching flies by a light.

### BACKGROUND OF THE INVENTION

1. Field of the Invention

This invention relates to a flycatcher, particularly to one possible to be collapsed to become a small size and costing very cheap to make.

2. Description of the Prior Art

As shown in FIG. 1, a conventional flycatcher includes a container 1 with a cap 2, a guide bottom 3 with an opening 4 to communicate with the container 1, a lower conical base 6 fixed under the guide bottom 3, plural feet 8 vertically fixed around near the circumference of the lower conical base 6, and a bait plate 9 placed under the guide base 3. The internal space 5 is defined between the circumferential wall of the container 1 and the guide bottom 3, and a liquid can be poured in the internal space 5. Further, the guide bottom 3 is provided with a center opening 4, and the lower conical base 6 is provided with an opening 7.

However, the conventional flycatcher shown in FIG. 1 has a definite size and shape impossible to be collapsed to become smaller size owning to its material of plastic, in consistent to environment protection.

### SUMMARY OF THE INVENTION

This invention has been devised to offer a flycatcher collapsible for convenience of packaging and transporting.

The features of the invention are a circular disc, a net bag, plural support legs and an opaque conical bellows-shaped cover. The net bag is combined on the circular disc, and pulled to be fully lengthened upward by a L-shaped rod combined between the net bag and the circular disc. The plural support legs are positioned under the circular disc and stand inclinedly outward on the ground, and the opaque conical bellows-shaped cover is made as a paper lantern collapsible and positioned under the circular disc and hiding the support legs. Therefore, the flycatcher in the invention can be collapsed to become very small for convenience of packaging and transporting, in addition to catching flies by means of a light.

### BRIEF DESCRIPTION OF DRAWINGS

This invention will be better understood by referring to the accompanying drawing, wherein:

FIG. 1 is an exploded perspective view of a conventional flycatcher;

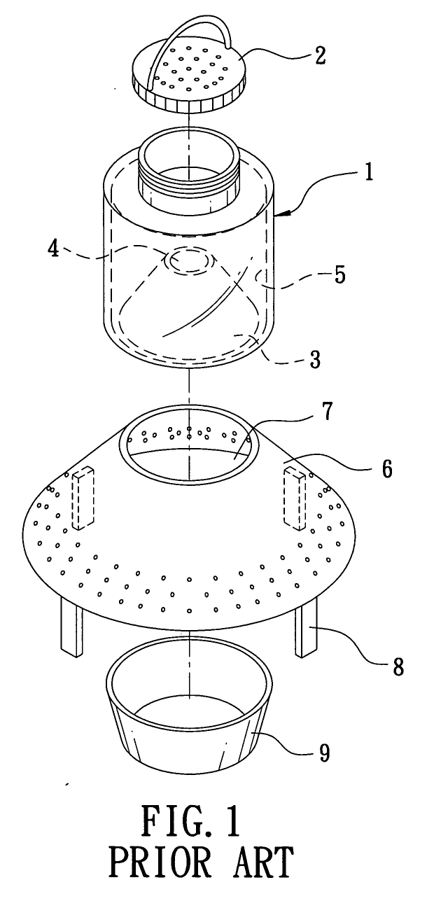

FIG. 2 is an exploded perspective view of a flycatcher in the present invention;

FIG. 3 is a side cross-sectional view of the flycatcher in the present invention;

FIG. 4 is front view of a conical bellows-shaped cover collapsed in the present invention;

FIG. 5 is a side cross-sectional view of the flycatcher in the present invention, showing a heavy thing or a weight hung inside it; and,

FIG. 6 is a side cross-sectional view of the flycatcher in the present invention, showing a tubular thing placed on a circular base.

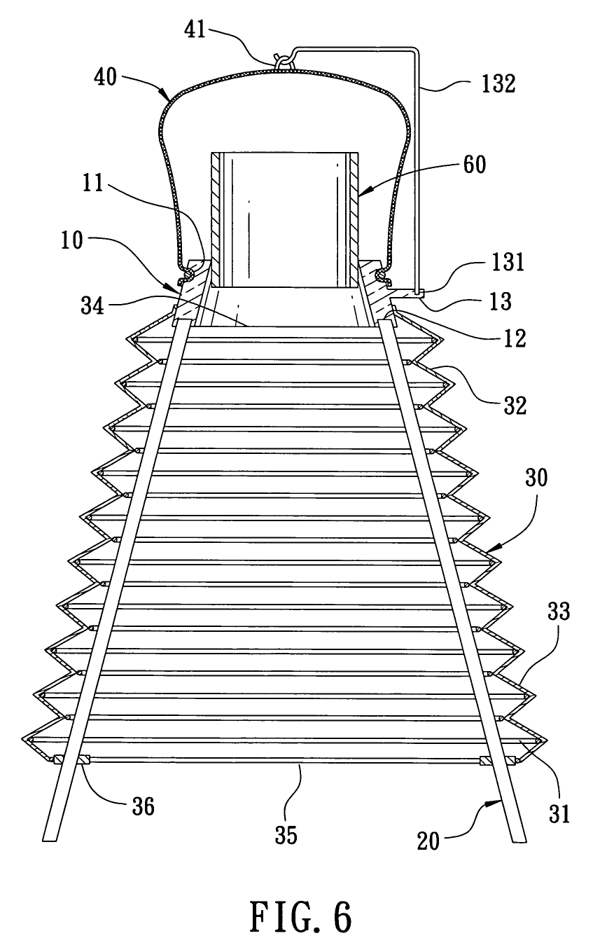

### DETAILED DESCRIPTION OF THE PREFERRED EMBODIMENT

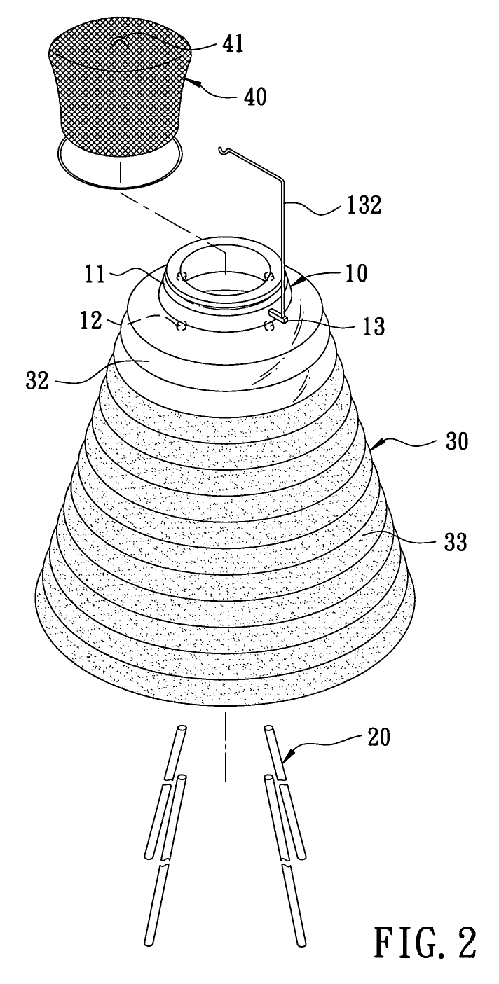

A preferred embodiment of a flycatcher in the present invention, as shown in FIGS. 2, 3 and 4, includes a circular disc 10, a plurality of support legs 20, an opaque conical bellows-shaped cover 30, and a net cover as main components combined together.

The circular disc 10 is made of transparent material, shaped a hollow cone and provided with a fitting member 11, a plurality of engaging holes 12 spaced apart in its bottom surface, an ear-like projection 13 fixed at an annular edge of the fitting member 11 and having a vertical fit hole 131, an L-shaped hang rod 132 fitted upward in the fit hole 131. The fitting member 11 is an annular groove, and the L-shaped hang rod 132 is made of iron wire.

The plurality of support legs 20 are made of wood, having their upper ends fitting in the engaging holes 12 of the circular disc 10, properly spaced apart to extend downward to stand on the ground or a flat surface and supporting the circular disc 10.

The opaque conical bellows-shaped cover 30 is shaped as a paper lantern, made of oiled paper and formed with a plurality of continual pointed knots 31 to permit the conical bellows-shaped cover 30 collapsible to become very small dimensions. Further the continual pointed knots 31 are composed of an upper half transparent portion 32 and a lower half opaque portion 33 so that the upper half portion 32 of the cover 30 makes up a transparent dimension and the lower half portion 33 an opaque dimension. Further, the bellows-shaped cover 30 has an upper opening 34, combined with a lower edge of the circular disc 10 by means of oilpaper attached around the opening 34, and formed with a lower opening 35 in its bottom. In addition, a restricting ring 36 is fitted around the lower section of the legs 20 for supporting the bottom of the bellows-shaped cover 30 a little above the ground.

The net bag 40 has a lower opening to fit around the fitting member 11 of the circular disc 10, located on the circular disc 10, and a hang ring 41 on the upper center to be hung by the upper end of the L-shaped hang rod 132 so as to keep the net bag 40 fully lengthened up. The net bag 40 is preferably provided with net holes smaller than the size of flies to be caught.

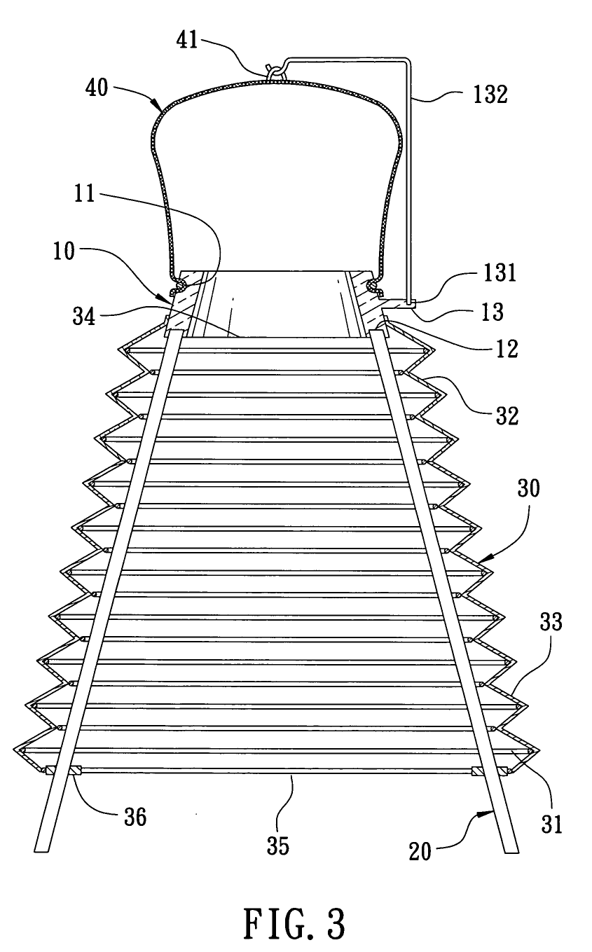

In using, as shown in FIGS. 2 and 3, firstly, the legs 20 are inserted through the restricting rings 36 located at the lower opening 35 of the bellows-shaped cover 30, with their upper ends fitting in the fitting holes of the circular disc 12, with the bellows-shaped cover 30 expanded to the preset size. Then the net bag 40 is combined with the circular disc 10 by fitting the lower opening of the net bag 40 around the fitting member 11, and the lower end of the hang rod 132 is fitted in the fitting hole 131 of the ear-like projection 13, with the upper end of the hang rod 312 hanging the hang ring 41 of the net bag 40 to let the net bag 40 fully lengthened up. Or the hang rod 312 can be bent for some extent, permitting the net bag half or not fully lengthened up. Therefore, when a fly is induced by bait placed on the bait plate to fly into the bellows-shaped cover 30 through the lower opening, the fly may be guided by the light in the upper half portion 33 of the cover 30 to finally into the bet bag 40 to be caught.

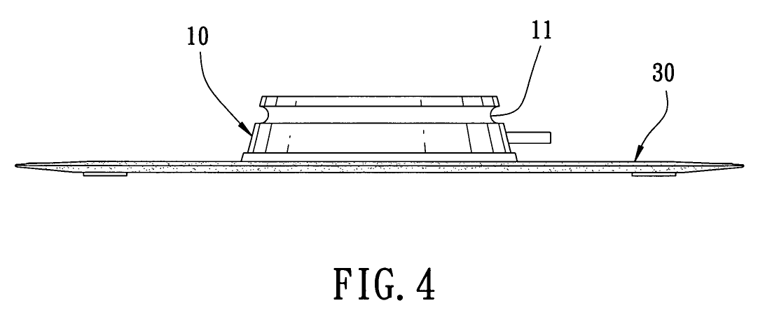

Moreover, for packaging or transporting, as shown in FIG. 4, the bellows-shaped cover 30 can be collapsed to fold down to become a very small size, reducing the cost for packaging and transportation.

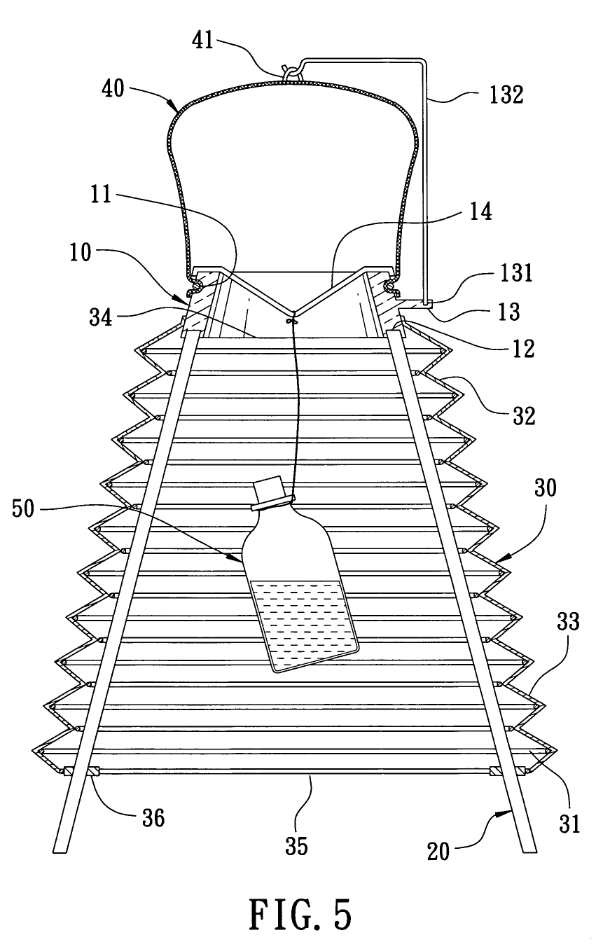

Besides, as shown in FIG. 5, in case there is a large or strong wind, a V-shaped rod 14 can be placed on the circular disc 10, and a weight or a heavy thing 50 can be hung on the V-shaped rod 14, keeping the flycatcher from blown away by the wind. The heavy thing may be a bottle with water filled therein.

The invention has the following advantages, as can seen from the foresaid description.

1. The upper half portion of the bellows-shaped cover 30 is transparent to make up a light source to induce flies flying into the cover 30 and then fly upward into the net bag 40 to be caught.

2. The bellows-shaped cover is made collapsible to become very small sized in case of not using, very convenient to put away, in addition to the rest components also possible to be taken off from each other so that the packaging and transporting can be very cheap, improving the disadvantage of the conventional flycatcher.

3. It is made of ecologically friendly materials, with its cost reduced for a large extent, potentially intriguing consumers.

While the preferred embodiment of the invention has been described above, it will be recognized and understood that various modifications may be made therein and the appended claims are intended to cover all such modifications that may fall within the spirit and scope of the invention.

What is claimed is:

1. A flycatcher comprising:
A circular disc shaped conical with a hollow interior, a fitting member formed in an annular upper side edge and plural engaging holes formed in an annular lower edge of said circular disc, an ear-like projection fixed sidewise under said annular groove and provided with a fitting hole, an L-shaped hang rod having its lower end fitted firmly in said fitting hole;
A plurality of support legs having upper ends fitting stably in said engaging holes of said circular disc for supporting said disc, said support legs respectively having a proper length and a lower end standing on a flat surface such as the ground;
A conical bellows-shaped cover made of opaque material and having a paper-lantern-like shape with a narrow upper side and a wide lower side, said cover provided with a plurality of continued annular pointed knots to permit said cover collapsible to fold down, said cover further provided with an upper opening possible to fit stably around said lower edge of said circular disc and a bottom opening, said support legs holding said cover with said bottom opening a little higher than the ground where said legs stand on;
A net bag having a lower opening to fit stably around said fitting member of said circular disc, a hang ring fixed on an upper center of said net bag, said hang ring possible to be hung by an upper end of said L-shaped hang rod so that said net bag can be kept fully lengthened upward, said net bag having net holes smaller than flies to be caught; and,
Said flycatcher inducing flies to fly into said cover from said lower opening of said bellows-shaped cover by a bait placed under said cover and then further flying upward and passing said cover into said net bag to be caught, said cover possible to be collapsed into a very small size for convenience of package, transportation and storing.

2. The flycatcher as claimed in claim 1, wherein said circular disc is made of transparent material.

3. The flycatcher as claimed in claim 1, wherein said bellows-shaped cover is provided with an upper half transparent portion.

4. The flycatcher as claimed in claim 1, wherein said fitting member of said circular disc is an annular groove.

5. The flycatcher as claimed in claim 1, wherein a restricting ring is provided to fit around each said support leg at points where said lower opening of said bellows-shaped cover are located.

6. The flycatcher as claimed in claim 1, wherein a V-shaped rod is further provided to be placed on said circular disc for hanging a proper weight for keeping said flycatcher from easily blown by a wind.

7. The flycatcher as claimed in claim 1, wherein a tubular body with a hollow interior is placed on said circular disc, extending upward in said net bag.
